(19) United States
(12) Patent Application Publication
(10) Pub. No.: US 2012/0162332 A1
(43) Pub. Date: Jun. 28, 2012

(54) SUBLIMATION INKS FOR THERMAL INKJET PRINTERS USING THERMALLY STABLE DYE PARTICLES

(75) Inventors: Dennis McKean, Hong Kong (HK); Francis Chee-Shuen LEE, Hong Kong (HK)

(73) Assignee: Hong Kong Applied Science and Technology Research Institute Company Limited, Hong Kong (HK)

(21) Appl. No.: 12/975,397

(22) Filed: Dec. 22, 2010

(51) Int. Cl. B41J 2/01; C09D 11/02

(52) U.S. Cl. 347/100; 106/31.13; 106/31.65; 106/31.33; 347/103

(57) ABSTRACT

Thermal inkjet printer sublimation inks are provided having high melting point suspended particles such that the ink does not clog thermal ink jet print heads. Low-cost thermal ink jet printers are used to create thermal transfer images from the inks which are used in conventional thermal transfer processes. An ink set having at least three ink colors includes an aqueous medium of 30-95 weight percent having particles of 50 nm to 1000 nm suspended therein in an amount of 1-10 weight percent. The suspended particles include a sublimation dye and have a melting point of at least a surface of the particle greater than or equal to 200° C. The particles may have a core-shell structure with a sublimation dye core. The ink includes one or more cosolvents from 4-40 weight percent, a surfactant of 0.01 to 5 weight percent, and a biocide of 0.01-5 weight percent.

### FIELD OF THE INVENTION

The present invention relates to sublimation inks in general and, more particularly, to sublimation inks including thermally stable dye particles that can be used in low-cost thermal inkjet printers.

### BACKGROUND

Sublimation inks are frequently used in transfer printing processes in which a reverse image is formed on a transfer printing medium. The reverse image of the transfer medium is accepted by a receiving substrate under the action of heat and, optionally, pressure, for a short period of time. During the heating process, the sublimation ink is converted directly from a solid to a vapor without passing through a liquid phase. The rapid release of ink permits transfer of high detail and deep colors. The transfer medium is typically a transfer sheet and can be used to transfer images to items having complex shapes that are not suited to other printing techniques. Consumer products such as ceramic mugs, mouse pads, key chains, etc. are particularly suited to be printed using transfer sheets having sublimation ink images.

Sublimation ink images are generally formed on a transfer sheet using piezoelectric inkjet printers. In piezoelectric printers, a transducer formed from a piezoelectric material such as PZT vibrates in response to addressing circuitry. The pressure from the vibration causes an ink droplet to be expelled from an ink nozzle to form an image. However, piezoelectric printers are more costly than the more widely-used thermal inkjet printers. In thermal ink jet printers, thin film firing resistors are addressed by addressing circuitry. A brief voltage pulse through the thin film resistor generates heat sufficient to form a small bubble in the ink. As the bubble grows, an ink droplet is ejected from a nozzle onto a substrate. Subsequent collapse of the bubble generates a vacuum which draws additional ink into the print head from the cartridge. These printers are low-cost as no special materials are needed to form a piezoelectric transducer.

However, because heat is involved in thermal inkjet printers, prior art formation of sublimation ink transfer sheets has generally been performed in piezoelectric printers. Prior art sublimation inks typically include low melting point disperse dyes (melting temperatures lower than 200° C.). The heat generation in the thermal inkjet printers results in the partial melting of the disperse dye and solidification on the heater and other printhead surfaces upon cooling, causing printhead failure.

Thus there is a need in the art for improved sublimation inks which can be used in conventional thermal inkjet printers to create transfer sheets.

### SUMMARY OF THE INVENTION

The present invention provides thermal inkjet printer sublimation inks having high melting point suspended particles; the ink passes through the thermal ink jet nozzles without clogging the nozzles caused by melting or partial melting of dyes which can occur with low melting point sublimation inks. In this way, low-cost thermal ink jet printers are used to create thermal transfer images on thermal transfer media which are then usable in conventional thermal transfer processes.

In particular, the present invention relates to an aqueous thermal inkjet printer sublimation ink set having at least three ink colors for forming thermal transfer printing media. Each ink of the ink set includes an aqueous medium using water as a solvent in an amount of 30-95 weight percent based on the total weight of the ink. Particles of 50 nm to 1000 nm are suspended in the aqueous medium. The suspended particles each include a sublimation dye and are present in an amount of 1 to 10 weight percent. Each particle has a melting point of at least a surface of the ink particle greater than or equal to 200° C. The inks include one or more cosolvents in an amount from 5 to 40 weight percent, a surfactant in an amount from 0.01 to 5 weight percent, and a biocide in an amount from 0.01 to 5 weight percent.

In an exemplary embodiment, the ink particles have a core-shell structure in which a sublimation dye core having a melting point lower than 200° C. is surrounded by a higher melting-point material such as silica, alumina or organic pigments. The overall core-shell particle in this case does not melt when brought into transient contact with surfaces over 200° C. due to the protection afforded by the shell layer of the composite particle. Alternatively, the ink particles comprise sublimation dyes having melting points of 200° C. or greater. The viscosity and surface tension of the inks are carefully controlled for thermal ink jet printer conditions.

### BRIEF DESCRIPTION OF THE DRAWINGS

FIG. 1 depicts an example of a core-shell particle used in the inks of the present invention.

FIG. 2 depicts an example of another core-shell particle used in the inks of the present invention.

### DETAILED DESCRIPTION

As discussed above, prior art printing of sublimation inks for transfer media have relied on piezoelectric printers for image formation. In general, it appears that the prior art believed that the failure of thermal inkjet printers to form acceptable images was due to at least partial sublimation of the dyes before the ink could be received on a suitable transfer medium. However, as determined in the present invention, failure in thermal inkjet printers is primarily due to agglomeration of dye in the printhead, likely due to melting or partial melting of the dye. Therefore, the present invention provides ink particles that will not clog a thermal printhead. The ink particles of the present invention have a melting point of at least a surface of the ink particle greater than or equal to 200° C. and include a sublimation dye. The expression “a melting point of at least a surface of the ink particle greater than or equal to 200° C.,” as used herein, means particles that are composed entirely of material that has a melting point of greater than or equal to 200° C. or ink particles that have a surface treatment or coating such that the surface does not melt when the ink particles are brought into transient contact with surfaces heated to over 200° C. even when the interior of the ink particle may include a material with a melting point of less than 200° C.

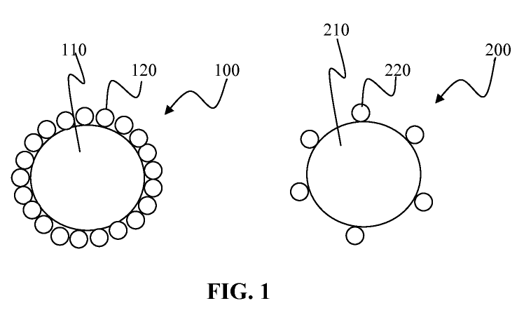

FIG. 1 depicts a core-shell particle 100 for use in the thermal inkjet sublimation inks of the present invention. Particle 100 includes a core 110 of a sublimation dye having a melting point lower than 200° C. A shell 120 is made up of plural outer particles that can substantially encircle the sublimation dye or partially encircle the sublimation dye (as seen with particle 200 having core 210 and plural outer particles 220). Particles 120 and 220 may be inorganic particles, such as silica or alumina, or particles of a high melting point pigment of the same color as the sublimation dye. In FIG. 1, an exemplary sublimation dye is Disperse Red 60 and an exemplary pigment particle is Pigment Red 122 having a melting point of 345° C. However, it is understood that numerous combinations of sublimation dyes and pigments satisfy the conditions set forth above (outer particles with a melting point equal or greater than 200° C. and inner sublimation dyes with a melting point of less than 200° C. Any such combination having these features is contemplated for use in the present invention.

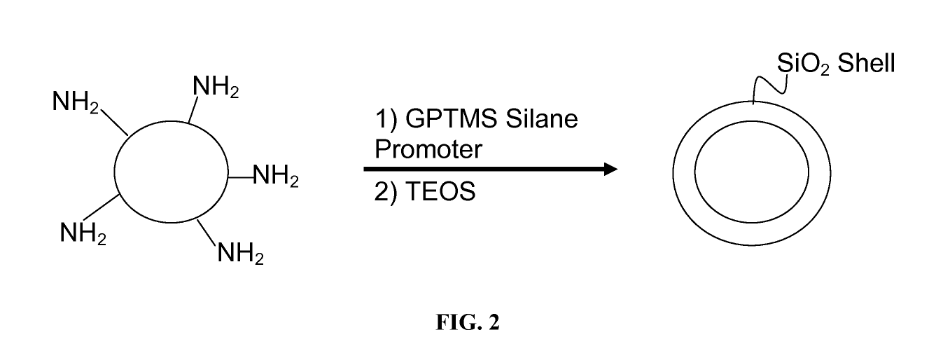

FIG. 2 depicts another core-shell particle 300 for use in the thermal sublimation inks of the present invention. In FIG. 2, a low melting point sublimation dye particle (lower than 200° C.) is coated with a silica-forming precursor such as 3-glycidoxypropyltrimethoxysilane. The precursor is reacted with tetraethoxysilane in the presence of a promoter to yield a full or partial silica shell surrounding the dye particle (Disperse Red 60 in the example of FIG. 2). The size of the resulting core-shell particle is 50-1000 nanometers, more preferably 100-500 nanometers and even more preferably, 200-400 nanometers. Of this total thickness, the thickness of the shell is on the order of 25-75 nanometers. While this is an exemplary method for forming a core-shell particle, any other process that can coat a sublimation dye with a precursor that can react to form a thin inorganic or organic coating having a melting point greater than or equal to 200° C. is contemplated for use in the present invention.

Alternatively, the sublimation dye is selected from sublimation dyes having a melting point higher than 200° C. Exemplary sublimation dyes for red, yellow, and blue inks are set forth below:

Red: Solvent Red 179, Disperse Red 19, Disperse Red 370, Disperse Red 11, N,N-bis(2′-cyanoethyl)-4-(4″-nitrophenylazo)aniline, N-(2′-hydroxyethyl)-N-(3″-oxobutyl)-4-(4′″-nitrophenylazo)aniline, 4-(4′-nitrophenylazo)-N-phenylmorpholine.

Yellow: Disperse yellow 82, disperse yellow 3, disperse yellow 54, disperse yellow 232.

Blue: Disperse blue 14, 1,4-Di(2′-hydroxyethylamino)-1,4-anthraquinone.

Although these sublimation dyes are exemplary dyes for use in the present invention, it is understood that other dyes having a melting point greater than or equal to 200° C. may be used in the present invention and, as such, the above invention is not limited to the above dyes. Examples of other suitable dyes having melting points equal to or greater than 200° C. may be found in The Sigma-Aldrich Handbook of Stains, Dyes, and Indicators, Green, Floyd J., Aldrich Chemical Co., 1990, the disclosure of which is incorporated by reference herein.

The particle size for the high melting point sublimation dyes is 50-1000 nanometers, more preferably 100-500 nanometers and even more preferably, 200-400 nanometers.

An ink set is provided using the above particles; the ink set includes at least red, yellow, and blue inks. The ink particles are provided in an amount of 1-10 weight percent of the total ink composition, more preferably 2-8 weight percent and even more preferably 3-6 weight percent.

The ink particles are suspended in an aqueous medium; the aqueous medium includes water in an amount from 30-95 weight percent, more preferably 40-90 weight percent and, even more preferably from 60-85 weight percent. Optionally, up to 5 weight percent of the water may be substituted by isopropyl alcohol or other suitable drying enhancing agent to enhance the drying properties of the ink.

To ensure adequate dispersion of the ink particles in the aqueous medium, a surfactant is used in an amount from 0.01 to 5 weight percent, more preferably from 0.05 to 3 weight percent and, even more preferably from 0.1 to 2 weight percent. Exemplary surfactants include polydimethylsiloxane copolymers such as Silwet surfactants, particularly, Silwet 7200, Silwet 7604, and Silwet 8600, however it is understood that other surfactants may also used in the inks of the present invention. Exemplary surfactants useful in the present invention are disclosed in the Handbook of Industrial Surfactants: An International Guide to More Than 21,000 Products by Trade Name, Composition, Application, and Manufacturer by Michael Ash and Irene Ash (June 1997), Gower Publishing Company The amount of surfactant selected also affects the desired surface tension of the ink, as discussed below.

Cosolvents are also provided in the ink compositions of the present invention to assist in preventing the drying of ink and subsequent clogging of the nozzles. Exemplary cosolvents include glycerol, 1,2-propylene glycol, and dipropylene glycol in an amount from 5-40 weight percent of the total ink composition, more particularly 8-30 weight percent and, even more particularly, 10-25 weight percent.

Additional ingredients may be optionally added to the ink composition to further enhance long term ink stability and storage properties. In particular, a biocide is preferably added to prevent ink fouling. A preferred biocide is Procel GXL in an amount from 0.01 to 5 weight percent, more particularly from 0.05 to 3 weight percent and, more particularly, from 0.01 to 2 weight percent.

As thermal ink jet printing is particularly sensitive to ink viscosity and surface tension characteristics, the above ingredients are balanced to provide suitable viscosity and surface tension to facilitate formation of an ink droplet during the heating process. The fluid dynamics of thermal inkjet printing often refer to the following equation:

$$\frac{{( γ ρ a )}^{1 / 2}}{η} = {Z}^{- 1}$$

where Z is the Ohnesorge number, the ratio between Reynolds number and Weber number; γ is the ink surface tension; ρ is the ink density; a is the radius of the printhead orifice; and η is the ink viscosity.

For most commercial inkjet printers, Z⁻¹ falls between 1 and 10. If it is small, viscosity is the dominant parameter and a large pressure pulse is required to eject the droplet, leading to low droplet velocity. If it is large it leads to very large liquid column extension before droplets are formed. Thus careful balance of ink properties (γ, ρ, η) are required for proper jetting characteristics. As thermal inkjet orifice diameters can vary and, over time, have typically become smaller, the properties of the inventive inks can be varied to accommodate these changes in diameter. According to the present invention, viscosity is selected to be in a range from 1 to 8 centipoise, more particularly 1.5 to 6 centipoise and, even more particularly, from 2 to 4 centipoise. Surface tension is selected to be from 22 to 57 dyne/cm, more particularly from 25 to 55 dyne/cm and, even more particularly, from 30 to 50 dyne/cm.

Drying speed is also important to image formation on transfer media. In the present invention, for compositions without isopropyl alcohol, the drying speed is less than 180 seconds, more preferable less than 120 seconds, and even more preferably, less than 60 seconds. When a drying enhancing agent such as isopropyl alcohol is included, the drying speed is less than 150 seconds, more preferably less than 90 seconds, and even more preferably less than 60 seconds.

The ink set of the present invention can form images via thermal ink jet printing onto a variety of transfer media substrates. Exemplary substrates include thermal transfer paper which has been specially coated to facilitate release of the inks in the sublimation transfer process onto the final recipient article. Transfer papers useful in the thermal ink jet process of the present invention include UP7260M available from Upsilon Enterprise Co., Inc.

The ink sets of the present invention are suitable for use in thermal ink jet printers, such as commercially available Lexmark thermal inkjet printers, to form transfer images on transfer media. Ink sets of red, yellow, and blue are loaded into the printer along with the transfer media and images subsequently printed from electronic image information.

While the foregoing invention has been described in terms of the above exemplary embodiments, it is understood that various modifications and variations are possible. Accordingly, such modifications and variations are within the scope of the invention as set forth in the following claims.

What is claimed is:

1. An aqueous thermal inkjet printer sublimation ink set having at least three ink colors for forming thermal transfer printing media, each ink of the ink set comprising:
an aqueous medium including water as a solvent in an amount from 30-95 weight percent based on the total weight of the ink;
suspended particles of 50 nm to 1000 nm, the suspended particles each including a sublimation dye and being dispersed in the aqueous medium, the suspended particles being present in an amount of 1 to 10 weight percent and having a melting point of at least a surface of the ink particle greater than or equal to 200° C.;
one or more cosolvents in an amount from 5 to 40 weight percent;
a surfactant in an amount from 0.01 to 5 weight percent; and
a biocide in an amount from 0.01 to 5 weight percent.

2. An aqueous thermal inkjet printer sublimation ink set according to claim 1 wherein the suspended particles including a sublimation dye have a composite core-shell structure.

3. An aqueous thermal inkjet printer sublimation ink set according to claim 2 wherein the shell comprises inorganic particles or particles of a pigment dye.

4. An aqueous thermal inkjet printer sublimation ink set according to claim 3 wherein the inorganic particles are silica or alumina particles.

5. An aqueous thermal inkjet printer sublimation ink set according to claim 2 wherein the shell comprises a continuous silica phase.

6. An aqueous thermal inkjet printer sublimation ink set according to claim 2 wherein the core comprises a sublimation dye having a melting point of less than 200° C. and the shell comprises particles of a pigment dye having a melting point greater than or equal to 200° C. such that the composite core-shell particle does not melt when brought into transient contact with surfaces greater than 200° C.

7. An aqueous thermal inkjet printer sublimation ink set according to claim 4 wherein the core comprising a sublimation dye having a melting point of less than 200° C. is Disperse Red 60 and the shell comprising particles of a pigment dye having a melting point greater than or equal to 200° C. is Pigment Red 122.

8. An aqueous thermal inkjet printer sublimation ink set according to claim 1 wherein the viscosity of the ink is from 1 to 8 centipoise.

9. An aqueous thermal inkjet printer sublimation ink set according to claim 1 wherein the surface tension of the ink is from 22 to 57 dyne/cm.

10. An aqueous thermal inkjet printer sublimation ink set according to claim 1 wherein the ink set ink colors comprise red, yellow and blue.

11. An aqueous thermal inkjet printer sublimation ink set according to claim 10 wherein the suspended particles including a sublimation dye for the red ink include a sublimation dye selected from one or more of Solvent Red 179, Disperse Red 19, Disperse Red 370, Disperse Red 11, N,N-bis(2′-cyanoethyl)-4-(4″-nitrophenylazo)aniline, N-(2′-hydroxyethyl)-N-(3″-oxobutyl)-4-(4′″-nitrophenylazo)aniline, or 4-(4′-nitrophenylazo)-N-phenylmorpholine.

12. An aqueous thermal inkjet printer sublimation ink set according to claim 11 wherein the suspended particles including a sublimation dye for the blue ink include a sublimation dye selected from one or more of Disperse blue 14 or 1,4-Di(2′-hydroxyethylamino)-1,4-anthraquinone.

13. An aqueous thermal inkjet printer sublimation ink set according to claim 12 wherein the suspended particles including a sublimation dye for the yellow ink include a sublimation dye selected from one or more of Disperse yellow 82, disperse yellow 3, disperse yellow 54, or disperse yellow 232.

14. An aqueous thermal inkjet printer sublimation ink set according to claim 1 wherein the suspended particles are 100 nm to 500 nm.

15. An aqueous thermal inkjet printer sublimation ink set according to claim 1 wherein the suspended particles are 200 nm to 400 nm.

16. An aqueous thermal inkjet printer sublimation ink set according to claim 1 wherein the suspended particles are present in an amount from 2 to 8 weight percent.

17. An aqueous thermal inkjet printer sublimation ink set according to claim 1 wherein the suspended particles are present in an amount from 3 to 6 weight percent.

18. A method of making sublimation transfer media comprising:
providing a sublimation ink transfer substrate to a thermal inkjet printer;
thermal ink jetting the ink set of claim 1 to create a transfer image on the sublimation ink transfer substrate.
